(19) United States
(12) Patent Application Publication
(10) Pub. No.: US 2015/0204615 A1
(43) Pub. Date: Jul. 23, 2015

(54) Dendritic Tube Circular Fin Heat Exchanger

(71) Applicant: ALCATEL-LUCENT, Paris (FR)

(72) Inventors: Jason P. Stafford, Wexford (IE); Brian G. Donnelly, Dublin (IE); Nicholas M. Jeffers, Wicklow (IE)

(73) Assignee: ALCATEL-LUCENT, Paris (FR)

(21) Appl. No.: 14/158,351

(22) Filed: Jan. 17, 2014

(51) Int. Cl. F28D 15/00; B23P 15/26; F28F 1/12

(52) U.S. Cl. CPC F28D 15/00; F28F 1/12; B23P 15/26

(57) ABSTRACT

Various exemplary embodiments relate to a heat exchanger configured to be attached to a cooling fan having a fan hub and a plurality of fan blades the cooling fan configured to produce airflow, said airflow having a first airflow rate at a first location and a different second airflow rate at a different second location, the heat exchanger including: an inlet manifold; an outlet manifold; a plurality of inlet tubes connected to the inlet manifold; a plurality of outlet tubes connected to the outlet manifold and the plurality of inlet tubes; and a plurality of concentric circular fins connected to the plurality of tubes, wherein the plurality of concentric circular fins have different radii such that a first spacing between a pair of adjacent first and second concentric circular fins corresponds to the first location and a second spacing between a pair of adjacent third and a fourth concentric circular fins corresponds to the second location and the first spacing is different from the second spacing.

### TECHNICAL FIELD

Various exemplary embodiments disclosed herein relate generally to heat exchangers and cooling assemblies.

### BACKGROUND

Many devices and machines require cooling. To maintain lower temperatures, designs have traditionally employed active cooling or passive cooling. Depending on the design requirements of the system one may favor one type of cooling over the other. In instances where the cooling requirements are strenuous, active cooling designs are preferred to more consistently meet higher demands.

Heat exchangers have been used in many active cooling designs. For example, the automotive industry has used radiators to cool engines. Additionally, computers and power supplies generate heat and many times require active cooling. However, in order to meet increasing cooling demands in an efficient manner designs must evolve to provide more efficient performance.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a heat exchanger configured to be attached to a cooling fan having a fan hub and a plurality of fan blades the cooling fan configured to produce airflow, said airflow having a first airflow rate at a first location and a different second airflow rate at a different second location, the heat exchanger including: an inlet manifold; an outlet manifold; a plurality of inlet tubes connected to the inlet manifold; a plurality of outlet tubes connected to the outlet manifold and the plurality of inlet tubes; and a plurality of concentric circular fins connected to the plurality of tubes, wherein the plurality of concentric circular fins have different radii such that a first spacing between a pair of adjacent first and second concentric circular fins corresponds to the first location and a second spacing between a pair of adjacent third and a fourth concentric circular fins corresponds to the second location and the first spacing is different from the second spacing.

Various exemplary embodiments relate to a cooling assembly including: a fan including: a fan hub; and a plurality of fan blades the cooling fan configured to produce airflow, said airflow having a first airflow rate at a first location and a different second airflow rate at a different second location; and a heat exchanger including: an inlet manifold; an outlet manifold; a plurality of inlet tubes connected to the inlet manifold; a plurality of outlet tubes connected to the outlet manifold and the plurality of inlet tubes; and a plurality of concentric circular fins connected to the plurality of tubes, wherein the plurality of concentric circular fins have different radii such that a first spacing between a pair of adjacent first and second concentric circular fins corresponds to the first location and a second spacing between a pair of adjacent third and a fourth concentric circular fins corresponds to the second location and the first spacing is different from the second spacing.

Various embodiments are described wherein the plurality of inlet tubes and the plurality of outlet tubes branch at least once prior to connecting to each other; wherein the cross-sectional area of the plurality of inlet tubes and the plurality of outlet tubes is reduced after branching; wherein location of the branching occurs more frequently as the spacing between the concentric circular fins decreases; wherein each of the concentric circular fins has the same thickness; wherein there are no concentric circular fins placed in locations where the velocity profile has a magnitude of zero; and wherein the heat exchanger is made of aluminum or copper.

Various exemplary embodiments relate to a method of manufacturing a heat exchanger configured to be attached to a cooling fan having a fan hub and a plurality of fan blades the cooling fan configured to produce airflow, said airflow having a first airflow rate at a first location and a different second airflow rate at a different second location, the method including: placing a plurality of concentric circular fins connected to the plurality of tubes, wherein the plurality of concentric circular fins have different radii such that a first spacing between a pair of adjacent first and second concentric circular fins corresponds to the first location and a second spacing between a pair of adjacent third and a fourth concentric circular fins corresponds to the second location and the first spacing is different from the second spacing.

Various embodiments are described further comprising calculating branching distances for the plurality of inlet tubes and outlet tubes based on the spacing of the concentric circular cooling fins; further comprising calculating the cross-sectional area of the plurality of inlet tubes and outlet tubes based on the spacing of the concentric circular cooling fins and the branching locations; wherein the plurality of inlet tubes and the plurality of outlet tubes are evenly spaced and the branching distance is the same for every inlet tube and outlet tube; further comprising removing any concentric circular fins placed in locations where the velocity profile has a magnitude of zero; and wherein the placing step is also based on the properties of the metal used to produce the plurality of concentric circular cooling fins.

### BRIEF DESCRIPTION OF THE DRAWINGS

In order to better understand various exemplary embodiments, reference is made to the accompanying drawings, wherein:

FIG. 1a illustrates an exemplary fan from related prior art;

FIG. 1b illustrates an exemplary parallel tube heat exchanger from related prior art;

FIG. 1c illustrates an exemplary parallel tube cooling assembly from related prior art;

FIG. 2 illustrates an exemplary velocity profile of the exemplary fan;

FIG. 3a illustrates an exemplary design for dendritic tube loops;

FIG. 3b illustrates an exemplary design for dendritic tube loops with concentric circular fins;

FIG. 3c illustrates an exemplary dendritic heat exchanger assembly; and

FIG. 4 illustrates an isometric view of an exemplary dendritic heat exchanger assembly.

To facilitate understanding, identical reference numerals have been used to designate elements having substantially the same or similar structure and/or substantially the same or similar function.

### DETAILED DESCRIPTION

Traditionally, heat exchanger design has been driven by manufacturing concerns, matched to corresponding cooling fans only based roughly on size and global fan performance characteristics of pressure rise and flow rate.

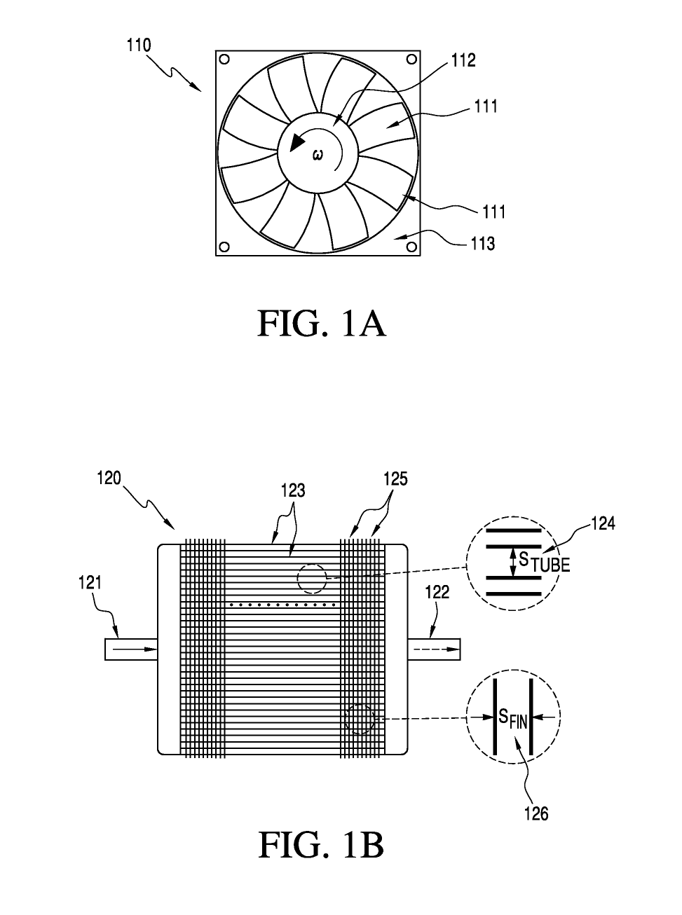

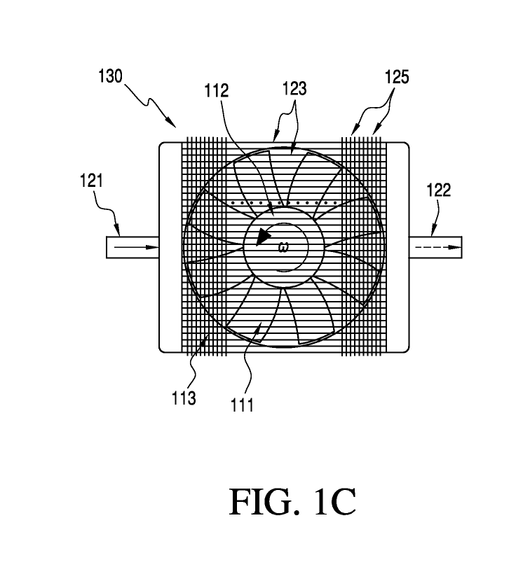

FIG. 1a illustrates an exemplary fan. Fan 110 includes fan housing 113. Fan housing 113 supports and encloses fan hub 112, which has multiple fan blades attached to it. Two instances of fan blade 111 have been labeled in FIG. 1a; however eight fan blades are present as illustrated. Fan hub 112 and all eight instances of fan blade 111 rotate counterclockwise with angular velocity (o) when fan 110 is powered. Because each fan blade 111 is angled, the angular velocity causes fan 110 to produce forced air.

FIG. 1b illustrates an exemplary parallel tube heat exchanger. Parallel tube heat exchanger 120 includes tubes 123 and fins 125. While a couple tubes and fins have been labeled, others are present, as illustrated in FIG. 1b. Tubes 123 connect inlet manifold 121 to outlet manifold 122. Tubes 123 are equally spaced apart by the distance tube spacing 124. Fins 125 run perpendicular to tubes 123 with fin spacing 126. These spacings allow forced air to move between tubes 123 and across fins 125 to cool the heat exchanger and the coolant or other fluid which passes though it.

FIG. 1c illustrates an exemplary parallel tube cooling assembly. Parallel tube cooling assembly 130 includes fan 110 and parallel tube heat exchanger 120. The view of parallel tube cooling assembly 130 demonstrates that there are significant regions of parallel tube heat exchanger 120 that do not receive airflow because they are not located over the region covered by fan blade 111 and therefore have minimal, if any, airflow across them. Housing 113 takes up most of the space in the four corners of parallel tube heat exchanger 120. Additionally, fan hub 112 takes up a significant portion of the center. These regions do not receive any consistent or significant airflow and create inconsistent cooling of parallel tube heat exchanger 120. Further, areas without significant airflow collect dust over time, which must be routinely cleaned to maintain the effectiveness of parallel tube cooling assembly 130. The trivial amount of airflow allows air containing dust to move through it, but due to the low velocity the dust can build up in these regions, reducing performance.

In view of the foregoing, it would be desirable to provide an improved heat exchanger which was designed with the airflow of the fan in mind. A design which optimized the geometry of the heat exchanger specifically for the airflow of the fan would make better use of the available airflow and reduce the need to remove dust, among other benefits.

Referring now to additional drawings, in which like numerals refer to like components or steps, there are disclosed broad aspects of various exemplary embodiments.

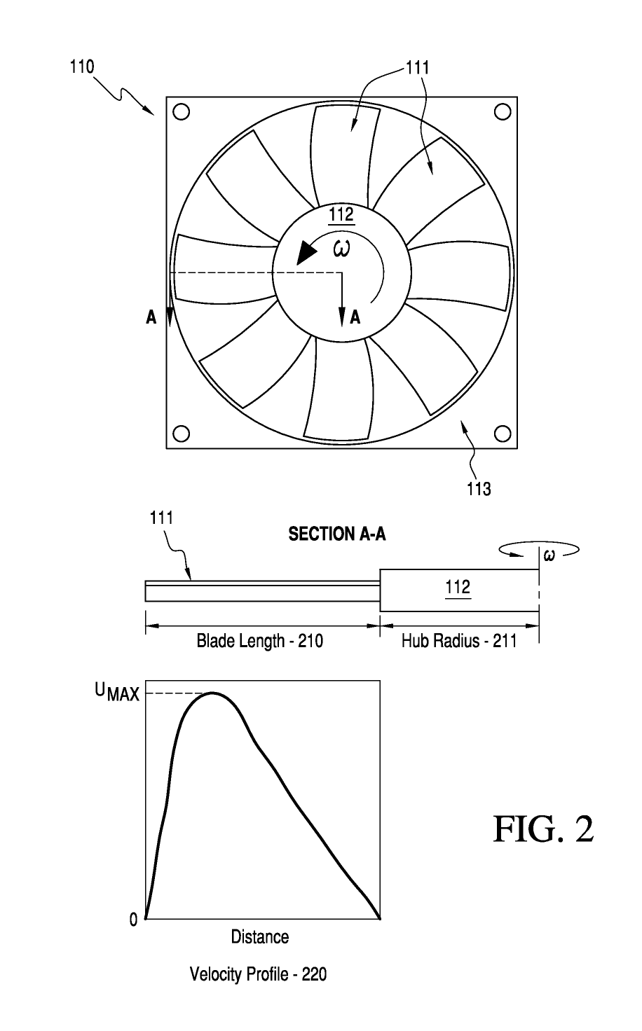

FIG. 2 illustrates an exemplary velocity profile of the exemplary fan. Fan 110 is illustrated again alongside a cross sectional view of fan hub 112 and fan blade 111. The plot of the velocity profile in FIG. 2 shows the airflow velocity as a function radial distance from the center of the fan. UMAX is the maximum airflow velocity produced by the fan. The cross sectional view highlights hub radius 211 and blade length 210. Below the cross sectional view is an exemplary velocity profile 220 corresponding to the air velocity at the corresponding locations of fan blade 111. Velocity profile 220 represents the time averaged air speed for each angular section that extends radially from the center of fan 110.

Velocity profile 220 is merely exemplary, and various fans will have different velocity profiles. Velocity profile is illustrated only for fan blade 111 because there is no substantial air movement over fan hub 112 for fan 110. Other fan designs may move air over the region of the fan hub. For those fans, it would be advantageous to measure the velocity profile to the center of the fan hub. Also, velocity profile 220 includes no information about the airflow across the corner regions of fan 110 because fan housing 113 prevents air flow in the corners. Should an alternative fan design cause airflow in these regions, the velocity profile should take that into account.

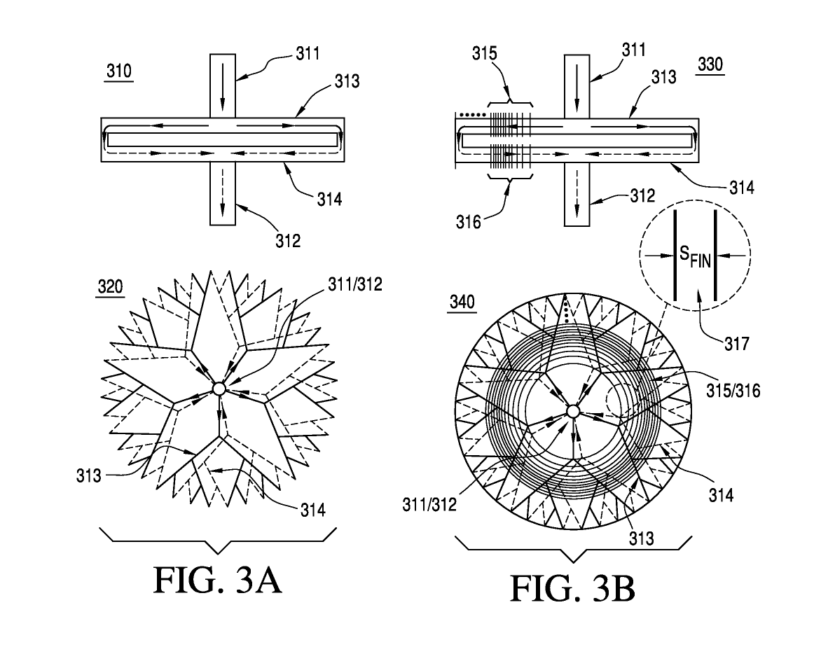

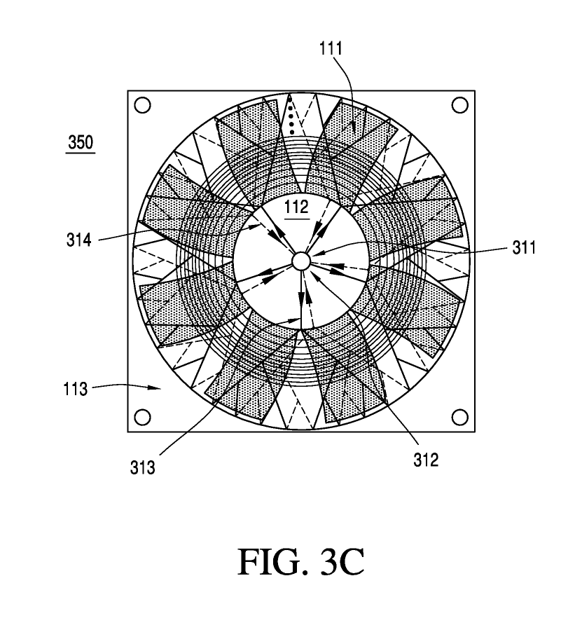

FIG. 3a illustrates an exemplary design for dendritic tube loops. FIG. 3a includes dendritic tube loops cross section view 310 and dendritic tube loops plane view 320. Both views show inlet manifold 311 connected to outlet manifold 312 via dendritic inlet tubes 311 flowing into dendritic outlet tubes 314.

Dendritic tube loops cross section view 310 highlights that as the fluid flows down from inlet manifold 311, it is forced out radially away from the center. Once it reaches the edges, fluid moves back towards the center, where outlet manifold 312 is located, via dendritic outlet tubes 314. The distance spanned by the tubes corresponds to the edge of the fan blade.

Dendritic plane view 320 highlights the layout of the tubes as they extend away from the center. The tubes take advantage of dendritic principles to disperse fluid more efficiently. As the tubes extend from the center they branch, or split, covering more area to take complete advantage of all areas which have airflow, based on the velocity profile. As the tubes branch their size or diameter may decrease to maintain consistent flow rates through all tubes and minimize the pressure losses in the dendritic tube loops. This design advantageously increases flow to all regions which receive airflow from the fan with low resistant pathways.

FIG. 3b illustrates an exemplary design for dendritic tube loops with concentric circular fins. FIG. 3b includes dendritic tube loops with fins cross section view 330 and dendritic tube loops with fins plane view 340.

Dendritic tube loops with fins cross section view 330 highlights the placement of circular inlet fins 315 along dendritic inlet tubes 313, as well as, circular outlet fins 316 along dendritic outlet tubes 314. These concentric circular fins emanate radially.

Dendritic tube loops with fins plane view 340 depicts the overlay of the concentric circular fins on the tube loops. As highlighted the fins have fin spacing 317. However, for each fin, fin spacing 317 will vary. In an exemplary embodiment, fin spacing 317 of circular inlet fins 315 will be the same as that of circular outlet fins 316. However, alternative embodiments may alter the fin spacing of each to better suit the velocity profile of the fan. Regardless, the spacing will be advantageously inversely proportional to the magnitude of the velocity profile at that point. This creates a higher density of fins where there is more air moving. Where the air moves more slowly, there will be fewer fins to cool with forced air. By matching high flow areas with a higher density of surfaces to cool, the design advantageously spatially matches the cooling pattern of the fan to the surfaces which its air is meant to cool. This allows for an even cooling pattern with no hot spots.

In alternative embodiments, the amount of branching and the branching locations may be altered to better match the flow based to the density of circular inlet fins 315 and circular outlet fins 316. In other embodiments a standard dendritic tube structure is set prior to calculating the fin spacing, and is not altered afterwards. This has the advantage of being easier to design because there are fewer variables to consider, the tradeoff being that there may be efficiency gains that could be made by altering the structure of the flow, but are not considered.

Also, advantageously, the design may consider the thickness of the fins, the thickness of the tube walls, and the material used to create the heat exchanger. These are additional variables that may be taken account of in the design to further optimize the transfer of heat to efficiently cool the coolant or other fluid used.

FIG. 3c illustrates an exemplary dendritic heat exchanger assembly. This view of dendritic heat exchanger assembly 350 depicts the layout of the dendritic tube loops and circular fins in relation to the fan. By comparing FIG. 3c with FIG. 1c, it is observable that the dendritic design better matches the airflow of the fan. The heat exchanger does not extend into the corner regions of fan housing 113. Also, there are no fins over fan hub 112. This follows the design rule that there are no cooling fins over areas where there is not airflow. In other words, the heat exchanger should be designed so that there are no items to be cooled in regions where the velocity profile has a magnitude of zero. In alternative embodiments with alternative fans, the housing design and fan hub structure may create airflow over those regions. The layout of cooling fins and tubes may therefore extend into those regions in those cases. The exemplary rules governing the design is that the fin spacing (and hence fin density) is matched to the velocity profile of the fan, that is, as air velocity increases, the fin spacing decreases, and as the air velocity decreases, the fin spacing increases.

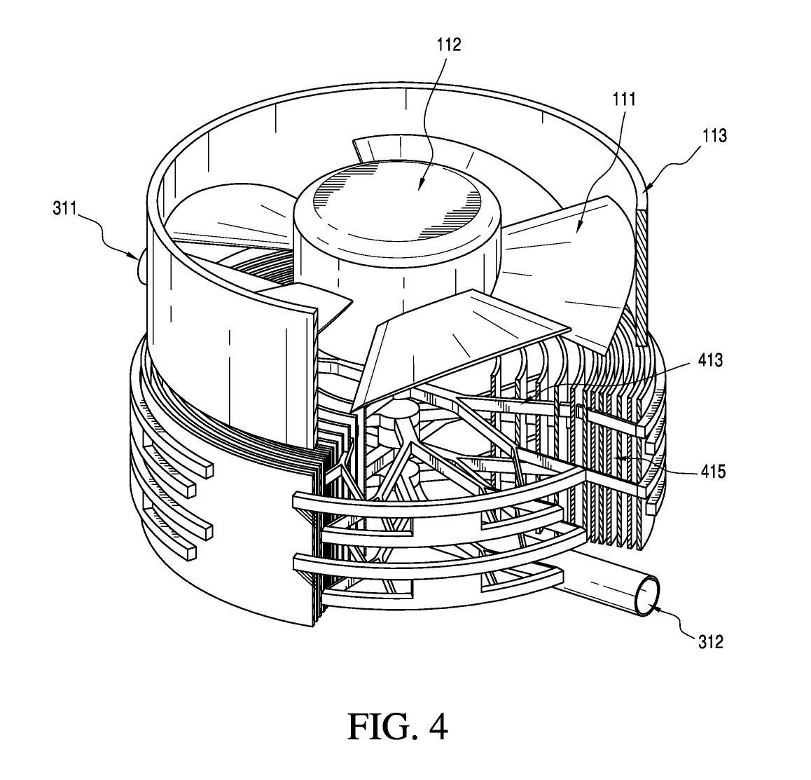

FIG. 4 illustrates an exemplary dendritic heat exchanger assembly with an isometric view. This further illustrates the complete dendritic heat exchanger assembly shown in FIG. 3c. Particularly highlighted in this view is a cutaway illustrating dendritic tubes 413 and circular fins 415. Inlet manifold 311 comes in one side to the center, which outlet manifold 312 extends from the center to the diametrically opposite side.

The heat exchanger including the fins and tubes may be made of aluminum, aluminum alloys, copper, or composite materials. Other thermally conductive metals are known in the art and could be used for part of the heat exchanger or the entire heat exchanger. Along the same lines, materials may be intermixed for different parts to provide optimal conductivity. Particular construction methods, such as casting, machining, welding, 3-D printing, and assembling, are known and the art and may be used to make the dendritic tube heat exchanger.

Additionally, dendritic tube heat exchanger may be attached direct to the corresponding fan or the two portions may individually connect to a larger housing. Other arrangements and assembly variants are known in the art and may be used to affix the heat exchanger and fan.

In designing the dendritic tube circular fin heat exchanger, particular steps may be followed to optimize the heat distribution based on the velocity profile of the fan used to cool the dendritic tube circular fin heat exchanger.

As a first step, a fan is selected to blow air over the heat exchanger as an active cooling measure. The velocity profile of the fan is measured using various methods known in the art. When the fan design creates airflow at the fan hub or through the housing, those regions must also be measured in determining the velocity profile. This profile is then transposed into a linear radial section profile as depicted in velocity profile 220.

As a second step, concentric circular fins and their corresponding spacing are laid out based upon the velocity profile. The spacing of the fins will be inversely proportional to the magnitude of the velocity profile. This will result in more fans being placed in areas of high flow, which will cool them more quickly. There will be fewer fins in regions where there is low airflow, with less cooling occurring.

Next, dendritic tubes are laid out to connect the fins and also provide structural stability for the fins. The dendritic tubes may use a standard branching design. However, the design may be altered based upon the fin spacing determined in the prior step. These modifications may change the branching points, section lengths, and thickness and cross sectional area of the tubes. In an exemplary embodiment, the pattern of the dendritic tubes is symmetrical about the center inlet and outlet manifolds. This allows even distribution of the coolant or other fluid.

The steps may be performed in additional variations such that the order may change. This would allow one skilled in the art to prioritize different aspects of the design driving the geometry of the heat exchanger. These variations should be readily apparent based on the description provided. However, a specific example includes recalculating the dendritic tube branching locations and tube cross sectional area and wall thicknesses based on the fin spacing and material properties.

After the design is complete, the dendritic tube circular fin heat exchanger may be manufactured using methods known in the art, such as machining, extruding, casting, and three dimensional printing. These methods may be used in various combinations depending on the materials involved and the final design requirements.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A heat exchanger configured to be attached to a cooling fan having a fan hub and a plurality of fan blades the cooling fan configured to produce airflow, said airflow having a first airflow rate at a first location and a different second airflow rate at a different second location, the heat exchanger comprising:
an inlet manifold;
an outlet manifold;
a plurality of inlet tubes connected to the inlet manifold;
a plurality of outlet tubes connected to the outlet manifold and the plurality of inlet tubes; and
a plurality of concentric circular fins connected to the plurality of tubes, wherein the plurality of concentric circular fins have different radii such that a first spacing between a pair of adjacent first and second concentric circular fins corresponds to the first location and a second spacing between a pair of adjacent third and a fourth concentric circular fins corresponds to the second location and the first spacing is different from the second spacing.

2. The heat exchanger of claim 1, wherein the spacing between the concentric circular fins is inversely proportional to a magnitude of the velocity profile of the cooling air over the concentric circular fins at that distance from the fan hub center.

3. The heat exchanger of claim 1, wherein the plurality of inlet tubes and the plurality of outlet tubes branch at least once prior to connecting to each other.

4. The heat exchanger of claim 2, wherein the cross-sectional area of the plurality of inlet tubes and the plurality of outlet tubes is reduced after branching.

5. The heat exchanger of claim 2, wherein location of the branching occurs more frequently as the spacing between the concentric circular fins decreases.

6. The heat exchanger of claim 1, wherein each of the concentric circular fins has the same thickness.

7. The heat exchanger of claim 2, wherein there are no concentric circular fins placed in locations where the velocity profile has a magnitude of zero.

8. The heat exchanger of claim 1, wherein the heat exchanger is made of aluminum or copper.

9. A cooling assembly comprising:
a fan comprising:
a fan hub; and
a plurality of fan blades the cooling fan configured to produce airflow, said airflow having a first airflow rate at a first location and a different second airflow rate at a different second location; and
a heat exchanger comprising:
an inlet manifold;
an outlet manifold;
a plurality of inlet tubes connected to the inlet manifold;
a plurality of outlet tubes connected to the outlet manifold and the plurality of inlet tubes; and
a plurality of concentric circular fins connected to the plurality of tubes, wherein the plurality of concentric circular fins have different radii such that a first spacing between a pair of adjacent first and second concentric circular fins corresponds to the first location and a second spacing between a pair of adjacent third and a fourth concentric circular fins corresponds to the second location and the first spacing is different from the second spacing.

10. The cooling assembly of claim 8, wherein the plurality of inlet tubes and the plurality of outlet tubes branch at least once prior to connecting to each other.

11. The cooling assembly of claim 9, wherein the cross-sectional area of the plurality of inlet tubes and the plurality of outlet tubes is reduced after branching.

12. The cooling assembly of claim 9, wherein location of the branching occurs more frequently as the spacing between the concentric circular fins decreases.

13. The cooling assembly of claim 8, wherein each of the concentric circular fins has the same thickness.

14. The cooling assembly of claim 8, wherein said airflow has a third airflow rate at a third location and the third airflow rate is substantially zero and wherein no concentric circular fins are placed in the third location.

15. The cooling assembly of claim 8, wherein the heat exchanger is made of aluminum or copper.

16. A method of manufacturing a heat exchanger configured to be attached to a cooling fan having a fan hub and a plurality of fan blades the cooling fan configured to produce airflow, said airflow having a first airflow rate at a first location and a different second airflow rate at a different second location, the method comprising:
placing a plurality of concentric circular fins connected to the plurality of tubes, wherein the plurality of concentric circular fins have different radii such that a first spacing between a pair of adjacent first and second concentric circular fins corresponds to the first location and a second spacing between a pair of adjacent third and a fourth concentric circular fins corresponds to the second location and the first spacing is different from the second spacing.

17. The method of claim 16, further comprising:
determining branching distances for the plurality of inlet tubes and outlet tubes based on the spacing of the concentric circular cooling fins.

18. The method of claim 17, further comprising:
determining the cross-sectional area of the plurality of inlet tubes and outlet tubes based on the spacing of the concentric circular cooling fins and the branching locations.

19. The method of claim 17, wherein the plurality of inlet tubes and the plurality of outlet tubes are evenly spaced and the branching distance is the same for every inlet tube and outlet tube.

20. The method of claim 16, further comprising:
removing any concentric circular fins placed in locations where the flow rate has a magnitude of zero.
